(19) United States
(12) Patent Application Publication
(10) Pub. No.: US 2019/0172606 A1
(43) Pub. Date: Jun. 6, 2019

(54) MULTICOAXIAL CABLE

(71) Applicant: SUMITOMO ELECTRIC INDUSTRIES, LTD., Osaka (JP)

(72) Inventor: Takaya KOHORI, Kanuma-shi (JP)

(73) Assignee: SUMITOMO ELECTRIC INDUSTRIES, LTD., Osaka (JP)

(21) Appl. No.: 15/910,371

(22) Filed: Mar. 2, 2018

(30) Foreign Application Priority Data
Dec. 1, 2017 (JP) 2017-231712

(51) Int. Cl. H01B 7/00; H01B 11/20; H01B 7/18; H01B 7/04; H01B 11/00

(52) U.S. Cl. CPC H01B 7/0009; H01B 11/20; H01B 11/002; H01B 7/04; H01B 7/1875

(57) ABSTRACT

A multicoaxial cable includes a core wire which includes a first unit formed by twisting two first insulated electric wires, each of the first insulated electric wires including a conductor and an insulating layer, the conductor being formed by stranding a plurality of child stranded conductors, each of the child stranded conductors being formed by stranding a plurality of conductor wires, and the insulating layer being formed to cover the conductor, and a sheath which covers the core wire. In the multicoaxial cable, a cross-sectional area of the conductor is 1.2 mm² to 3.5 mm², the conductor is formed of a hard-drawn copper wire, and an outer diameter of the insulating layer is 2.0 mm to 3.6 mm.

### CROSS-REFERENCE TO RELATED APPLICATION

This application claims priority from Japanese Patent Application No. 2017-231712, filed on Dec. 1, 2017, the entire subject matter of which is incorporated herein by reference.

### TECHNICAL FIELD

The present invention relates to a multicoaxial cable.

### BACKGROUND

JP-A-2014-220043 discloses an insulated electric cable including: a core wire formed by stranding a plurality of core members, each of the core members including a conductor and an insulating layer covering the conductor; a sheath that is formed to cover the core wire; and a paper tape that is disposed between the core wire and the sheath in a state of being wrapped around the core wire.

### SUMMARY

However, in the configuration of the insulated electric cable disclosed in JP-A-2014-220043, there is a room for improvement to both realize reduction in diameter and high bending resistance.

An object of the present invention is to provide a multicoaxial cable capable of realizing both reduction in diameter and high bending resistance.

In order to achieve the object, according to an aspect of the present invention, a multicoaxial cable according to an aspect of the present invention includes:

a core wire that includes a first unit formed by twisting two first insulated electric wires, each of the first insulated electric wires including a conductor and an insulating layer, the conductor being formed by stranding a plurality of child stranded conductors, each of the child stranded conductors being formed by stranding a plurality of conductor wires, and the insulating layer being formed to cover the conductor; and

a sheath that covers the core wire, wherein

a cross-sectional area of the conductor is 1.2 mm² to 3.5 mm²,

the conductor is formed of a hard-drawn copper wire, and

an outer diameter of the insulating layer is 2.0 mm to 3.6 mm.

In addition, in order to achieve the object, a multicoaxial cable according to another aspect of the present invention includes:

a core wire that is formed using a first insulated electric wire and a second insulated electric wire,

the first insulated electric wire including a conductor and an insulating layer, the conductor of the first insulated electric wire being formed by stranding a plurality of child stranded conductors, each of the child stranded conductors of the first insulated electric wire being formed by stranding a plurality of conductor wires, and the insulating layer of the first insulated electric wire being formed to cover the conductor,

the second insulated electric wire including a conductor and an insulating layer, the conductor of the second insulated electric wire being formed by stranding a plurality of child stranded conductors, each of the child stranded conductors of the second insulated electric wire being formed by stranding a plurality of conductor wires, and the insulating layer of the second insulated electric wire being formed to cover the conductor; and

a sheath that covers the core wire, wherein

a cross-sectional area of the conductor of the first insulated electric wire is 1.2 mm² to 3.5 mm²,

the conductor of the first insulated electric wire is formed of a hard-drawn copper wire,

an outer diameter of the insulating layer of the first insulated electric wire is 2.0 mm to 3.6 mm,

a cross-sectional area of the conductor of the second insulated electric wire is 0.13 mm² to 0.75 mm²,

an outer diameter of the insulating layer of the second insulated electric wire is 1.0 mm to 2.2 mm, and

the core wire is formed by twisting a second unit with two first insulated electric wires, the second unit being formed by twisting two second insulated electric wires.

According to the present invention, a multicoaxial cable capable of realizing both reduction in diameter and high bending resistance can be provided.

### BRIEF DESCRIPTION OF THE DRAWINGS

FIG. 1 is a cross-sectional view illustrating a configuration of an insulated electric cable according to a first embodiment of the present invention;

FIG. 2 is a view illustrating a schematic configuration of a manufacturing device of manufacturing the insulated electric cable according to the first embodiment of the present invention;

FIG. 3 is a cross-sectional view illustrating a configuration of an insulated electric cable according to a second embodiment of the present invention;

FIG. 4 is a cross-sectional view illustrating a configuration of an insulated electric cable according to a third embodiment of the present invention; and

FIG. 5 is a schematic view illustrating an example of a bend test method.

### DETAILED DESCRIPTION

### Summary of Embodiment of Present Invention

First, the summary of an embodiment of the present invention will be described.

(1) A multicoaxial cable according to an embodiment of the present invention includes:

a core wire that includes a first unit formed by twisting two first insulated electric wires, each of the first insulated electric wires including a conductor and an insulating layer, the conductor being formed by stranding a plurality of child stranded conductors, each of the child stranded conductors being formed by stranding a plurality of conductor wires, and the insulating layer being formed to cover the conductor; and

a sheath that covers the core wire, wherein

a cross-sectional area of the conductor is 1.2 mm² to 3.5 mm²,

the conductor is formed of a hard-drawn copper wire, and

an outer diameter of the insulating layer is 2.0 mm to 3.6 mm.

The multicoaxial cable having the above-described configuration is a small-diameter cable in which the cross-sectional area of the conductor of the first insulated electric wire and the outer diameter of the insulating layer are in the above-described ranges. The conductor of the first insulated electric wire is formed of a hard-drawn copper wire. Therefore, the bending resistance of the cable can be improved.

(2) In addition, a multicoaxial cable according to an embodiment of the present invention includes:

a core wire that is formed using a first insulated electric wire and a second insulated electric wire,

the first insulated electric wire including a conductor and an insulating layer, the conductor of the first insulated electric wire being formed by stranding a plurality of child stranded conductors, each of the child stranded conductors of the first insulated electric wire being formed by stranding a plurality of conductor wires, and the insulating layer of the first insulated electric wire being formed to cover the conductor,

the second insulated electric wire including a conductor and an insulating layer, the conductor of the second insulated electric wire being formed by stranding a plurality of child stranded conductors, each of the child stranded conductors of the second insulated electric wire being formed by stranding a plurality of conductor wires, and the insulating layer of the second insulated electric wire being formed to cover the conductor; and

a sheath that covers the core wire, wherein

a cross-sectional area of the conductor of the first insulated electric wire is 1.2 mm² to 3.5 mm²,

the conductor of the first insulated electric wire is formed of a hard-drawn copper wire,

an outer diameter of the insulating layer of the first insulated electric wire is 2.0 mm to 3.6 mm,

a cross-sectional area of the conductor of the second insulated electric wire is 0.13 mm² to 0.75 mm²,

an outer diameter of the insulating layer of the second insulated electric wire is 1.0 mm to 2.2 mm, and

the core wire is formed by twisting a second unit with two first insulated electric wires, the second unit being formed by twisting two second insulated electric wires.

According to this configuration, the multicoaxial cable includes the second unit. The second unit is formed by twisting the two second insulated electric wire. In each of the two second insulated electric wires, the cross-sectional area of the conductor is in a range of 0.13 mm² to 0.75 mm², and the outer diameter of the insulating layer is in a range of 1.0 mm to 2.2 mm. With the multicoaxial cable including the second unit, multiple systems can be operated using the single cable. Therefore, the convenience of the cable can be improved. In addition, a reduction in diameter and high bending resistance of the multicoaxial cable can be both realized.

(3) In addition, in the multicoaxial cable according to (2) described above,

the core wire may further include a third unit that is formed by twisting two third insulated electric wires,

each of the third insulated electric wires may include a conductor and an insulating layer,

the conductor may have a cross-sectional area of 0.13 mm² to 0.75 mm²,

the insulating layer may be formed to cover the conductor and have an outer diameter of 1.0 mm to 2.2 mm, and

the core wire may be formed by stranding the first insulated electric wires, the second unit, and the third unit with each other.

According to this configuration, the multicoaxial cable includes the third unit. The third unit is formed by the twisting two third insulated electric wires. In each of the third second insulated electric wires, the cross-sectional area of the conductor is in a range of 0.13 mm² to 0.75 mm², and the outer diameter of the insulating layer is in a range of 1.0 mm to 2.2 mm. With the multicoaxial cable including the third unit, multiple types of systems can be operated using the single cable. Therefore, the convenience of the cable can be further improved. In addition, a reduction in diameter and high bending resistance of the multicoaxial cable including the first to third units can be both realized.

(4) In addition, in the multicoaxial cable according to any one of (1) to (3) described above,

the sheath may include a first cover layer and a second cover layer,

the first cover layer may cover a periphery of the core wire, and

the second cover layer may cover a periphery of the first cover layer.

According to this configuration, the sheath is formed of the two cover layers. As a result, the stranding of the core wire does not appear on the sheath.

(5) In addition, in the multicoaxial cable according to (4) described above,

the first cover layer may be formed of a material that is more flexible than that of the second cover layer.

Since the first cover layer is formed of a material that is more flexible than that of the second cover layer, the cable having high flexibility, bending resistance, and wear resistance can be provided.

(6) In addition, in the multicoaxial cable according to (4) or (5) described above,

the first cover layer may be formed of a foamed material.

With this configuration, the bending resistance can be further improved.

(7) In addition, the multicoaxial cable according to any one of (1) to (6) described above may further include:

a tape member that is disposed between the core wire and the sheath in a state of being wrapped around a periphery of the core wire.

According to this configuration, the tape member is disposed between the core wire and the sheath such that the core wire and the sheath are separated from each other. Therefore, by removing the tape member, the core wire and the sheath can be easily separated from each other to expose the core wire. This way, with this configuration, the workability of an operation of taking the core wire out can be improved.

(8) In addition, in the multicoaxial cable according to any one of (1) to (6) described above,

powder may be applied to the periphery of the core wire, and

the periphery of the core wire to which the powder is applied may be covered with the sheath.

According to this configuration, the powder is applied to the periphery of the core wire, and the periphery is covered with the sheath. Therefore, the core wire and the sheath can be easily separated from each other to expose the core wire.

(9) In addition, in the multicoaxial cable according to any one of (1) to (8) described above,

a stranding pitch at which the child stranded conductors may be stranded is less than a twisting pitch at which the two first insulated electric wires are twisted, and

the twisting pitch at which the two first insulated electric wires are twisted may be 4 times or less the stranding pitch at which the child stranded conductors are stranded.

With this configuration, the bending resistance of the conductor of the first insulated electric wire can be improved while maintaining the productivity of the multicoaxial cable.

### Details of Embodiment of Present Invention

Hereinafter, examples of the embodiments of the multicoaxial cable according to the present invention will be described in detail with respect to the drawings.

### First Embodiment

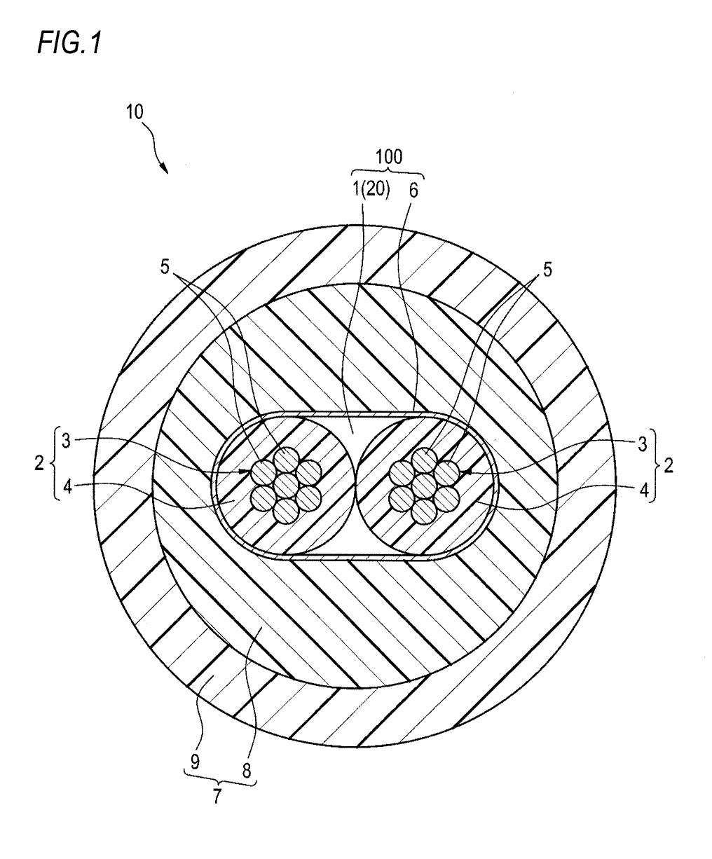

FIG. 1 is a cross-sectional view illustrating a configuration of an insulated electric cable 10 (an example of the multicoaxial cable) according to a first embodiment of the present invention. The insulated electric cable 10 is used for, for example, an electromechanical brake mounted on a vehicle, and can be used as a cable for supplying electric power to a motor that drives a brake caliper. In particular, the insulated electric cable 10 is used for an electromechanical parking brake (EPB).

As illustrated in FIG. 1, the insulated electric cable 10 includes: a core wire 1; a tape 6 (an example of the tape member) that is wrapped around the core wire 1; and a sheath 7 (an example of the sheath) that covers an outer periphery of the tape 6 wrapped around the core wire 1. The outer diameter of the insulated electric cable 10 according to the example is in a range of 6 to 12 mm and preferably in a range of 7.0 to 10.5 mm.

The core wire 1 is formed by twisting two insulated electric wires 2 (an example of the first insulated electric wire) having substantially the same diameter as each other. That is, the core wire 1 includes a main unit 20 (an example of the first unit) that is formed by twisting the two insulated electric wires 2 with each other. Each of the two insulated electric wires 2 includes a conductor 3 and an insulating layer 4 that is formed to cover an outer periphery of the conductor 3.

The conductor 3 is formed of a plurality of (in this example, seven) child stranded conductors 5. The child stranded conductors 5 substantially the same structure. Each of the child stranded conductors 5 is formed as a stranded wire that is formed by stranding a plurality of conductor wires having an outer diameter of 0.05 to 0.16 mm as hard-drawn copper wires. The conductor 3 is formed as a stranded wire that is formed by stranding a plurality of child stranded conductors (stranded wires) 5. The number of wires constituting one child stranded conductor 5 is in a range of 16 to 100 and preferably in a range of 30 to 75. The cross-sectional area of the conductor 3 having the above-described configuration (the total cross-sectional area of the wires) is in a range of 1.2 to 3.5 mm². In addition, the outer diameter of the conductor 3 is in a range of 1.3 to 3.0 mm and preferably in a range of 2.0 to 2.6 mm.

As the hard-drawn copper wire constituting the conductor 3 according to the embodiment, the hard-drawn copper wire defined according to JIS C 3101-1994 can be used. The hard-drawn copper wire is obtained by drawing copper at a normal temperature, and is not annealed unlike the annealed copper wire. The hard-drawn copper wire refers to a robust copper wire that is difficult to deform, and is distinguished from an annealed copper wire that is easily deformable. That is, the hard-drawn copper wire refers to a copper wire having a higher breaking strength than the annealed copper wire.

For example, the insulating layer 4 may be a polyolefin resin such as polyethylene (for example, low-density polyethylene (LDPE), high-density polyethylene (HDPE), or very-low-density polyethylene (VLDPE), or a mixture thereof), polypropylene, an ethylene-ethyl acrylate copolymer (EEA), or an ethylene-vinyl acetate copolymer (EVA), an olefin resin other than a polyolefin resin, a polyurethane resin, a fluororesin (for example, a tetrafluoroethylene-ethylene copolymer), or a compound obtained by mixing at least two kinds of the above-described compounds with each other. The insulating layer 4 may be formed of, for example, a resin material which is imparted with flame retardancy by being mixed with a flame retardant. In addition, a material constituting the insulating layer 4 may be crosslinked. The thickness of the insulating layer 4 is about 0.2 to 0.6 mm. In order to reduce the diameter of the multicoaxial cable 10, it is preferable that the thickness of the insulating layer 4 is small. However, in order to increase bending resistance and to maintain wear resistance, it is necessary to secure the thickness in a predetermined range. The outer diameter of the insulated electric wire 2 including the insulating layer 4 is in a range of 2.0 to 3.6 mm. From the viewpoint of improving bending resistance, it is preferable that the insulating layer 4 is formed of a flexible resin material.

The insulating layer 4 may have a two-layer structure. In this case, from the viewpoint of improving bendability, it is preferable that an inner layer (a layer positioned immediately outside of the conductor 3) is formed of a relatively flexible resin having a Young's modulus of 700 MPa or lower at 25° C. and that an outer layer is formed of a relatively hard resin having a Young's modulus of higher than 700 MPa at 25° C.

A parent stranding pitch of the conductor 3 (a pitch at which the child stranded conductors 5 are stranded) can be set according to the outer diameter of the conductor 3 and the like. The parent stranding pitch of the conductor 3 is, for example, about 20 to 80 mm. In addition, a twisting pitch at which the two insulated electric wires 2 constituting the main unit 20 are twisted can be set according to the outer diameter of the insulated electric wire 2 and the like. The twisting pitch of the two insulated electric wires 2 is, for example, about 40 to 150 mm. In the embodiment, the parent stranding pitch of the conductor 3 is set to be less than the twisting pitch of the two insulated electric wires 2, and the twisting pitch of the two insulated electric wires 2 is set to be 4 times or less the parent stranding pitch of the conductor 3. It is preferable that the twisting pitch of the two insulated electric wires 2 is set to be 1.1 times to 3 times the parent stranding pitch of the conductor 3. As a result, the bending resistance of the conductor 3 can be improved while maintaining the productivity of the insulated electric cable 10.

The tape 6 is helically wrapped around the outer periphery of the core wire 1 and is disposed between the core wire 1 and an inner sheath 8 described below. The thickness of the tape 6 is in a range of 0.01 to 0.1 mm. As a material of the tape 6, paper or an artificial fiber formed of a resin material such as polyester may be used. In addition, a wrapping method of the tape 6 may be helical wrapping or longitudinal wrapping. In addition, a wrapping direction of the tape 6 may be opposite to a twisting direction of each of the insulated electric wires 2 of the core wire 1. By setting the wrapping direction of the tape 6 and the twisting direction of the insulated electric wires 2 to be opposite to each other, the surface of the tape 6 wrapped around the periphery of the core wire 1 is not likely to be uneven, and the outer diameter of the insulated electric cable 10 is likely to be stable.

FIG. 1 illustrates a state where the tape 6 is wrapped around the periphery of the core wire 1. However, the tape is not necessarily wrapped around the periphery of the core wire 1. The tape 6 is not necessary as long as the sheath 7 can be easily removed to take out the core wire 1. Instead of the tape 6, a release agent (for example, powder such as talc) may be interposed between the core wire 1 and the sheath 7.

The sheath 7 has a two-layer structure including an inner sheath 8 (an example of the first cover layer) and an outer sheath 9 (an example of the second cover layer), and is formed to cover the core wire 1 around which the tape 6 is wrapped (hereinafter, also referred to as “tape-wrapped core wire 100”).

The inner sheath 8 is formed to be extruded on the outer periphery of the tape-wrapped core wire 100 such that the tape-wrapped core wire 100 is covered. As a material constituting the inner sheath 8, a material having high flexibility is preferable. For example, the material constituting the inner sheath 8 may be a polyolefin resin such as EEA, EVA, polyethylene (for example, very-low-density polyethylene (VLDPE)), polyurethane (for example, a thermoplastic polyurethane (TPU)), a polyurethane elastomer, a polyester elastomer, or a compound obtained by mixing at least two kinds of the above-described compounds with each other. The material constituting the inner sheath 8 may be crosslinked. For example, in a case where a flexible polyolefin resin such as EEA is used, heat resistance (for example, up to 150° C.) required for use in a vehicle can be obtained by crosslinking the resin material. In addition, in order to improve bending resistance, the material constituting the inner sheath 8 may be caused to foam. The thickness of the inner sheath 8 is about 0.2 to 1.0 mm. The outer diameter of the inner sheath 8 is in a range of 6.0 to 11.0 mm and preferably in a range of 7.3 to 9.3 mm.

The outer sheath 9 is formed to be extruded on an outer periphery of the inner sheath 8 such that the outer periphery of the inner sheath 8 is covered. As a material constituting the outer sheath 9, a material having high heat resistance and wear resistance is preferable. As the material constituting the outer sheath 9, for example, a flame-retardant polyurethane resin may be used. The polyurethane constituting the outer sheath 9 may be crosslinked in order to improve heat resistance. As described above, the outer diameter of the outer sheath 9, that is, the outer diameter of the insulated electric cable 10 is about 6 to 11 mm.

The inner sheath 8 and the outer sheath 9 may be the same material. In this case, the sheath 7 having a two-layer structure has the same appearance as that of the sheath having a single-layer structure. By extruding the same material twice, the outer diameter of the insulated electric cable 10 is likely to be uniform in a length direction thereof.

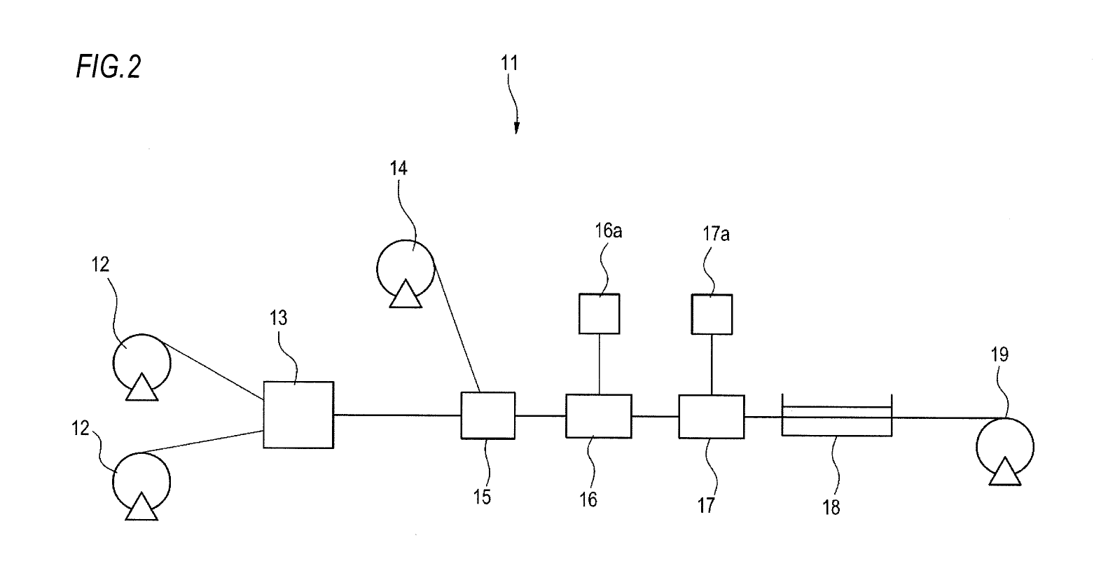

Next, a method of manufacturing the insulated electric cable 10 will be described. FIG. 2 illustrates a schematic configuration of a manufacturing device 11 for manufacturing the insulated electric cable 10. As illustrated in FIG. 2, the manufacturing device 11 includes two insulated electric wire supply reels 12, a stranding portion 13, a tape supply reel 14, a tape wrapping portion 15, an inner sheath extruding portion 16, an outer sheath extruding portion 17, a cooling portion 18, and a cable wrapping reel 19.

The insulated electric wire 2 is wrapped around each of the two insulated electric wire supply reels 12, and the two insulated electric wires 2 are supplied to the stranding portion 13. In the stranding portion 13, the supplied two insulated electric wires 2 are twisted with each other to form the core wire 1. The core wire 1 is transported to the tape wrapping portion 15.

In the tape wrapping portion 15, the core wire 1 transported from the stranding portion 13 and the tape 6 supplied from the tape supply reel 14 are joined together, and the tape 6 is helically wrapped around the outer periphery of the core wire 1 to form the tape-wrapped core wire 100. This tape-wrapped core wire 100 is transported to the inner sheath extruding portion 16. In a case where the tape 6 is not wrapped around the outer periphery of the core wire 1, the process and the device (tape wrapping portion 15) are not necessary. In a case where another release agent, for example, talc is interposed between the core wire 1 and the sheath 7 instead of the tape 6, a talc applying device is provided instead of the tape wrapping portion 15 so as to apply talc to the core wire 1 when the core wire 1 passes through the talc applying device.

The inner sheath extruding portion 16 is connected to a storage portion 16a where the resin material is stored. In the inner sheath extruding portion 16, the resin material supplied from the storage portion 16a is extruded on an outer periphery of tape-wrapped core wire 100. This way, the inner sheath 8 is formed to cover the outer periphery of the tape-wrapped core wire 100. The tape-wrapped core wire 100 covered with the inner sheath 8 is transported to the outer sheath extruding portion 17.

The outer sheath extruding portion 17 is connected to a storage portion 17a where the resin material is stored. In the outer sheath extruding portion 17, the resin material supplied from the storage portion 17a is extruded on the outer periphery of the inner sheath 8 formed by the inner sheath extruding portion 16. This way, the outer sheath 9 is formed to cover the outer periphery of the inner sheath 8, and the insulated electric cable 10 covered with the sheath 7 having a two-layer structure including the inner sheath 8 and the outer sheath 9 is formed. The insulated electric cable 10 is transported to the cooling portion 18 such that the sheath 7 is cooled and cured. Next, the insulated electric cable 10 is transported to the cable wrapping reel 19 and wrapped therearound.

Incidentally, for example, in an insulated electric cable that is used as a power line of an electromechanical brake of a vehicle, in order to allow a device such as an electromechanical brake to which power is supplied to reliably operate, it is necessary that a resistance value of a conductor is set to be a predetermined value or lower. Therefore, in a configuration of the related art in which a copper alloy wire is used as the conductor included in the insulated electric wire, in order to suppress the resistance value of the conductor, it is necessary that the diameter of the conductor is a predetermined value or more, and there is a room for improvement to realize reduction in diameter.

On the other hand, as described above, the insulated electric cable 10 according to the embodiment includes: the core wire 1 that is formed by twisting the two insulated electric wires 2; and the sheath 7 that is formed to cover the core wire 1, in which each of the insulated electric wires 2 includes the conductor 3 and the insulating layer 4, the conductor 3 is formed by stranding a plurality of child stranded conductors 5, and the insulating layer 4 is formed to cover the conductor 3. In the multicoaxial cable 10, the cross-sectional area of the conductor 3 is 1.2 mm² to 3.5 mm², the conductor 3 is formed of a hard-drawn copper wire, and the outer diameter of the insulating layer 4 is 2.0 mm to 3.6 mm. This way, in the insulated electric cable 10 according to the embodiment, the conductor 3 is formed of a hard-drawn copper wire having a higher breaking strength than an annealed copper wire. Therefore, in the insulated electric wire 2 (and the insulated electric cable 10 including the insulated electric wire 2), the cross-sectional area of the conductor 3 and the outer diameter of the insulating layer 4 are in the above-described ranges such that reduction in diameter can be realized, and the bending resistance of the insulated electric cable 10 can be improved compared to that of the related art in which the annealed copper wire is used.

In addition, the sheath 7 included in the insulated electric cable 10 according to the embodiment includes: the inner sheath 8 that covers the periphery of the core wire 1; and the outer sheath 9 that covers the periphery of the inner sheath 8. This way, by configuring the sheath 7 to have the two-layer structure including the inner sheath 8 and the outer sheath 9, the shape of a cross-section (a cross-section perpendicular to a cable length direction) of the insulated electric cable 10 can be made to be fixed along the cable length direction.

Since the inner sheath 8 is formed of a material that is more flexible than the outer sheath 9, the insulated electric cable 10 having high flexibility, bending resistance, and wear resistance can be provided.

In addition, the insulated electric cable 10 according to the embodiment further includes the tape 6 that is disposed between the core wire 1 and the sheath 7 in a state where the tape 6 is wrapped around the periphery of the core wire 1. This way, the tape 6 is disposed between the core wire 1 and the sheath 7, that is, is disposed such that the core wire 1 and the sheath 7 are separated from each other. As a result, by removing the tape 6, the core wire 1 and the sheath 7 can be easily separated from each other to expose the core wire 1. Thus, the workability of an operation of taking the core wire 1 (each of the insulated electric wires 2) out can be improved.

### Second Embodiment

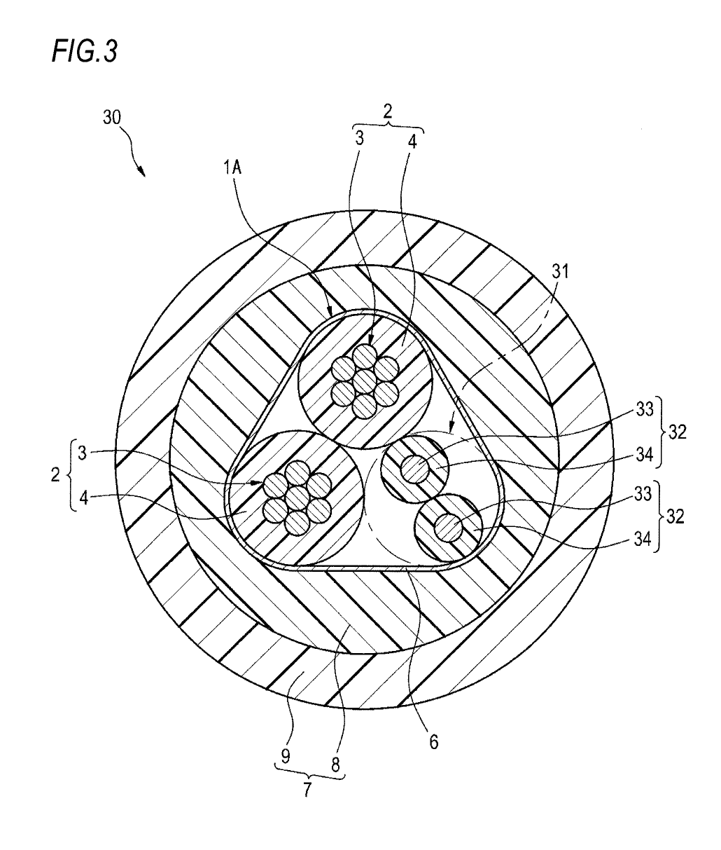

Next, a second embodiment of the present invention will be described with reference to FIG. 3. Components having the same configurations as those of the first embodiment are represented by the same reference numerals, and the description thereof will not be repeated. FIG. 3 illustrates a cross-section of an insulated electric cable 30 according to the second embodiment. The insulated electric cable 30 according to the embodiment can be used not only for supplying electric power to an electromechanical brake (for example, an electromechanical parking brake) but also for other uses, for example for transmitting an electric signal from a wheel speed sensor. In addition, the insulated electric cable 30 may be used for transmitting signals from other devices to a vehicle electronic control unit (ECU) or for transmitting signals from a vehicle ECU to devices.

As illustrated in FIG. 3, the insulated electric cable 30 according to the example is different from the first embodiment, in that a core wire 1A includes a sub-unit 31 (an example of the second unit) for transmitting a signal for, for example, a wheel speed sensor in addition to the two insulated electric wires 2 (main unit 20).

The sub-unit 31 is formed by twisting two insulated electric wires 32 (an example of the second insulated electric wire) having a smaller diameter than the insulated electric wire 2 constituting the main unit 20 and having substantially the same diameter as each other. Each of the two insulated electric wires 32 includes a conductor 33 and an insulating layer 34 that is formed to cover an outer periphery of the conductor 33.

The conductor 33 is a stranded wire that is formed by stranding a plurality of conductor wires formed of, for example, a copper alloy wire. The outer diameter of the wire is, for example, 0.05 to 0.15 mm, and the number of wires constituting one conductor 33 is about 40 to 80 and preferably 50 to 70. In addition, the cross-sectional area of the conductor 33 having the above-described configuration is in a range of 0.13 to 0.75 mm² and preferably in a range of 0.2 to 0.5 mm². In addition, the outer diameter of the conductor 33 is in a range of 0.5 to 1.0 mm. A material constituting the conductor 33 is not limited to the copper alloy wire, and any material having a predetermined conductivity and flexibility such as a tin-plated annealed copper wire or an annealed copper wire may be used. In addition, as the material constituting the conductor 33, a hard-drawn copper wire may be used as in the case of the conductor 3.

The insulating layer 34 is formed of, for example, a polyolefin resin. It is preferable that the insulating layer 34 is flame-retardant. In addition, the insulating layer 34 may be a crosslinked resin. The thickness of the insulating layer 34 is about 0.2 to 0.4 mm, and the outer diameter of the insulating layer 34 is about 1.2 to 1.6 mm. The insulating layer 34 may be formed of the same material as that of the insulating layer 4 of the insulated electric wire 2. For example, the insulating layer 34 may be formed of another material such as a fluororesin or polyurethane.

The sub-unit 31 having the above-described configuration and the two insulated electric wires 2 are bunch twisted to form the core wire 1A. A twisting pitch of the core wire 1A (the two insulated electric wires 2 and the sub-unit 31) may be in the same range as that of the core wire 1. The tape 6 is wrapped around an outer periphery of the core wire 1A, and the inner sheath 8 and the outer sheath 9 are extruded on an outer periphery of the tape 6. As a result, the insulated electric cable 30 is formed. The tape 6 is not necessarily provided, and another release agent may be interposed between the core wire 1A and the sheath 7 instead of the tape 6.

As described above, the core wire 1A of the insulated electric cable 30 according to the second embodiment includes the sub-unit 31, and the sub-unit 31 is formed by twisting the two insulated electric wires 32 in which the cross-sectional area of the conductor 33 is in a range of 0.13 mm² to 0.75 mm². The sub-unit 31 is twisted with the two insulated electric wires 2 to form the core wire 1A. It is preferable that the diameter of a twisted wire of the two insulated electric wires 32 is substantially the same (0.85 times to 1.15 times) as the diameter of one insulated electric wire 2. It is preferable that the twisted wire of the insulated electric wires 32 and the two insulated electric wires 2 are disposed in an isosceles triangular shape or an equilateral triangular shape as in a cross-section illustrated in FIG. 3. As a result, the combination shape of the core wire 1A is stable in the cable length direction, and the external shape (a circular cross-section in the length direction) of the insulated electric cable 30 is stable in the cable length direction. This way, in the insulated electric cable 30, the conductor 3 of the insulated electric wire 2 is formed of a hard-drawn copper wire (a copper wire in which the breaking strength is higher than that of the annealed copper wire and in which the resistance value of the conductor is a predetermined or lower despite a small diameter). Therefore, reduction in diameter and high bending resistance of the insulated electric cable 30 can be both realized. In addition, the insulated electric cable 30 including the core wire 1A can be used not only as a power line used for an electromechanical brake but also as, for example, a four-core insulated electric cable including a signal line through which an electric signal of a sensor or the like is transmitted. This way, with the insulated electric cable 30 according to the second embodiment, two types of systems can be operated using the single cable. Therefore, the convenience of the cable can be improved.

### Third Embodiment

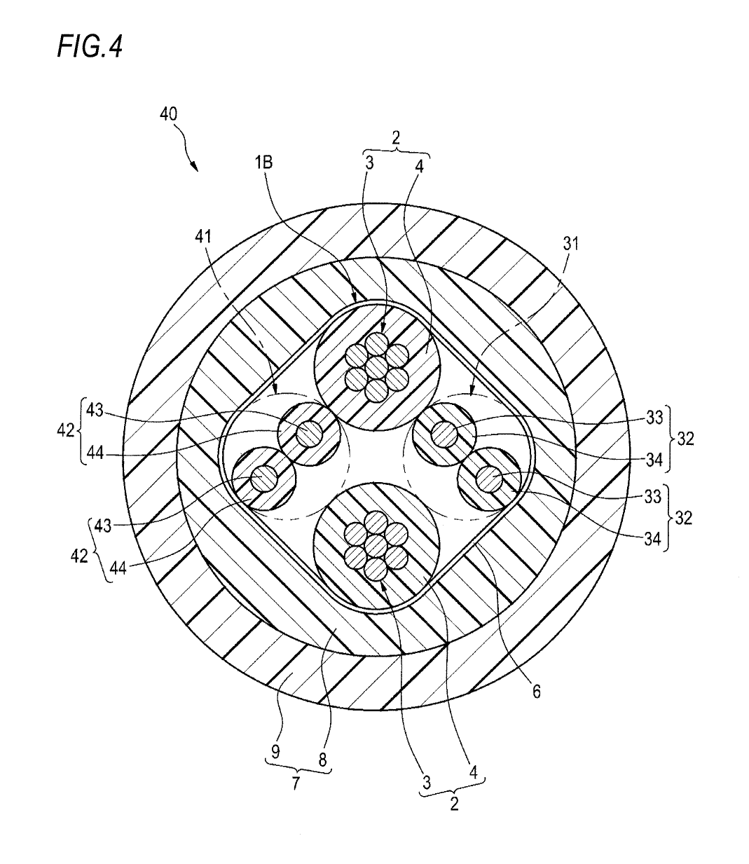

Next, a third embodiment of the present invention will be described with reference to FIG. 4. Components having the same configurations as those of the first embodiment and the second embodiment are represented by the same reference numerals, and the description thereof will not be repeated. FIG. 4 illustrates a cross-section of an insulated electric cable 40 according to the third embodiment.

As illustrated in FIG. 4, the insulated electric cable 40 according to the example is different from the second embodiment, in that the core wire 1B includes a sub-unit 41 (for example, an example of the third unit) in addition to the two insulated electric wires 2 constituting the main unit 20 and the sub-unit 31.

The sub-unit 41 is formed by twisting two insulated electric wires 42 (an example of the third insulated electric wire) having a smaller diameter than the insulated electric wire 2 and having substantially the same diameter as each other. Each of the two insulated electric wires 42 includes a conductor 43 and an insulating layer 44 that is formed to cover an outer periphery of the conductor 43. The configurations of the conductor 43 and the insulating layer 44 of the insulated electric wire 42 are substantially the same as the configurations of the conductor 33 and the insulating layer 34 of the insulated electric wire 32 of the sub-unit 31, and thus the detailed description thereof will not be repeated.

The sub-unit 41 having the above-described configuration, the two insulated electric wires 2, and the sub-unit 31 are bunch twisted to form the core wire 1B. A twisting pitch of the core wire 1B (the two insulated electric wires 2 and the sub-units 31 and 41) may be in the same range as that of the core wire 1 or 1A. The tape 6 is wrapped around an outer periphery of the core wire 1B, and the inner sheath 8 and the outer sheath 9 are extruded on an outer periphery of the tape 6. As a result, the insulated electric cable 40 is formed. The third embodiment is the same as the first embodiment or the second embodiment, in that the tape 6 is not necessarily provided and another release agent may be used instead of the tape 6.

It is preferable that the sub-unit 31 and the sub-unit 41 are not adjacent to each other and, as illustrated in FIG. 4, are disposed opposite to each other when seen from the two insulated electric wires 2. As a result, the combination shape of the core wire 1B is stable in the cable length direction, and the external shape of the insulated electric cable 40 is stable in the cable length direction.

As described above, the core wire 1B of the insulated electric cable 40 according to the third embodiment includes the sub-unit 41 in addition to the sub-unit 31, and the sub-unit 41 is formed by twisting the two insulated electric wires 42 in which the cross-sectional area of the conductor 43 is in a range of 0.13 to 0.75 mm². The sub-unit 41 is stranded with the main unit 20 and the sub-unit 31 to form the core wire 1B. This way, in the insulated electric cable 40, the conductor 3 of the insulated electric wire 2 included in the main unit 20 is formed of a hard-drawn copper wire. Therefore, reduction in diameter and high bending resistance of the insulated electric cable 40 can be both realized. In addition, the insulated electric cable 40 including the core wire 1B can be used not only as a power line used for an electromechanical brake but also as, for example, a six-core insulated electric cable including a signal line through which an electric signal of a sensor or the like is transmitted. This way, multiple types of systems can be operated using the single cable. Therefore, the convenience of the cable can be improved.

The present invention is not limited to the above-described first to third embodiments, and appropriate modifications, improvements, and the like can be made. In addition, the materials, dimensions, numerical values, forms, numbers, disposition positions, and the like of the respective components in the embodiments are arbitrary and are not limited as long as the present invention can be achieved.

The insulating layer 4 of the insulated electric wire 2 constituting the main unit 20 may be formed of one resin layer or two resin layers. In order to improve bending resistance, it is preferable that the insulating layer 4 is formed of two resin layers (an inner layer is formed of a resin that is more flexible than an outer layer). In addition, the insulating layer 34 of the insulated electric wire 32 constituting the sub-unit 31 and the insulating layer 44 of the insulated electric wire 42 constituting the sub-unit 41 may also be formed of one layer or two layers. In a case where the insulating layer 4, 34, or 44 is formed of two layers, an inner layer is formed of a relatively flexible material, and an outer layer is relatively hard material. The inner layer can be formed of, for example, a copolymer of ethylene and an a olefin having a carbonyl group, such as EEA, EVA, or EMA, or very-low-density polyethylene The outer layer can be formed of, for example, polyolefin.

In addition, in the description of the example of the first embodiment to the third embodiment, the sheath 7 is formed of two layers including the inner sheath 8 and the outer sheath 9. However, the present invention is not to the examples. For example, the sheath 7 may be formed of only the outer sheath 9 (that is, the sheath 7 may be formed of only one cover layer). In a case where the sheath formed of one layer is required to have wear resistance, it is preferable that the sheath is formed of polyurethane. In a case where high wear resistance is not required, the sheath may be formed of polyethylene (particular preferably, high-density polyethylene), polypropylene, or polyvinyl chloride (preferably, hard polyvinyl chloride).

In addition, in the second embodiment and the third embodiment, the sub-unit 31 or 41 is formed by twisting the two insulated electric wires 32 or 42. However, the present invention is not limited to this example. For example, the sub-unit may be formed by extruding a cover material on the periphery of the insulated electric wire 32 or 42 to cover the periphery. As a result, in a case where the sub-unit 31 or 41 is connected to a connection destination such as a vehicle sensor, molding can be performed without a gap. As the cover material that covers the periphery of the insulated electric wire 32 or 42, for example, polyurethane, polyethylene, or other polyolefin resins may be used. The cover material that covers the periphery of the insulated electric wire 32 or 42 may be formed of two layers. In a case where the cover material is formed of two layers, an inner layer and an outer layer may be formed of different materials or the same material. The inner layer may be formed of a flexible resin (having a relatively low Young's modulus), and the outer layer may be formed of a hard resin (having a relatively high Young's modulus). The cover material may be crosslinked. in addition, a shield layer may be provided around the periphery of the sub-unit 31 or 41. As the shield layer, a braid formed of a thin metal wire (a copper alloy wire, an annealed copper wire, or a hard-drawn copper wire) may be used, the thin metal wire may be helically wrapped around the periphery of the sub-unit 31 or 41, or a metal tape (a metal tape may adhere to a resin tape, or a metal may be deposited on a resin tape) may be wrapped around the periphery of the sub-unit 31 or 41. The metal tape may be used in combination with drain wire.

Next, examples of the present invention will be described. The following cables according to Examples 1 to 6 and Comparative Examples 1 to 6 were prepared, and a bending test was performed using each of the cables.

### Example 1

In Example 1, 50 conductor wires having an outer diameter of 0.08 mm which were formed of a hard-drawn copper wire having a higher breaking strength than the annealed copper wire were stranded to form a child stranded conductor (stranded wire) 5, and 7 child stranded conductors 5 were stranded to form a conductor 3 having an outer diameter 1.9 mm as a stranded wire. The outer periphery of the conductor 3 was covered with the insulating layer 4 formed of polyethylene to form the insulated electric wire 2 having an outer diameter of 2.7 mm. Two insulated electric wires 2 were twisted to form the core wire 1 (twisted pair). The outer periphery of the core wire 1 was covered with the sheath 7 (having a two-layer structure including the inner sheath 8 and the outer sheath 9; both the inner sheath 8 and the outer sheath 9 are formed of polyurethane) formed of polyurethane. As a result, the two-core insulated electric cable 10 having an outer diameter 7.7 mm was prepared. The thickness (thickness of the thinnest portion) of the sheath 7 was 1.15 mm. The stranding pitch of the child stranded conductor 5 was 38 mm (parent stranding), and the twisting pitch of the core wire 1 was 85 mm. The allowable current of the insulated electric wire 2 was 9.7 mΩ/m.

### Example 2

16 annealed copper wires having an outer diameter of 0.08 mm were stranded to form a child stranded wire, and 3 child stranded wires are stranded to form a twisted wire. This twisted wire was covered with polyethylene to prepare an insulated electric wire having an outer diameter of 1.4 mm. Two insulated electric wires were twisted to form the sub-unit 31. The sub-unit 31 and the two insulated electric wires 2 (as in the case of Example 1) were twisted to form the core wire 1A. The outer periphery of the core wire 1A was covered with the sheath 7 (having a two-layer structure including the inner sheath 8 and the outer sheath 9; both the inner sheath 8 and the outer sheath 9 are formed of polyurethane) formed of polyurethane. As a result, the four-core insulated electric cable 30 (having an outer diameter of 8.6 mm) was prepared. The thickness (thickness of the thinnest portion) of the sheath 7 was 1.15 mm. The stranding pitch of the conductor (the child stranded conductor 5) and the twisting pitch of the core wire 1A were the same as those of Example 1.

### Example 3

The sub-unit 41 having the same configuration as that of the sub-unit 31 was prepared. The two insulated electric wires 2, the sub-unit 31, and the sub-unit 41 were stranded to form the core wire 1B. The outer periphery of the core wire 1B was covered with the sheath 7 (having the same configuration as that of Examples 1 and 2) formed of polyurethane. As a result, the six-core insulated electric cable 40 (having an outer diameter of 9.3 mm) was prepared. The thickness (thickness of the thinnest portion) of the sheath 7 was 1.15 mm. The stranding pitch of the conductor (the child stranded conductor 5) and the stranding pitch of the core wire 1A were the same as those of Example 1.

### Example 4

A two-core insulated electric cable was prepared, the cable having the same configuration as that of Example 1 except that the insulating layer of the insulated electric wire (electric wire corresponding to the insulated electric wire 2) was formed of two layers. In the insulating layer formed of two layers, an inner layer (a layer adjacent to the outer periphery of the conductor) was formed of EVA (a relatively flexible resin), and an outer layer was formed of polyethylene (a relatively hard resin). The total thickness of the insulating layer was the same as the thickness of the insulating layer formed of one layer according to Example 1.

### Example 5

A four-core insulated electric cable was prepared, the cable having the same configuration as that of Example 2 except that the insulating layer of the insulated electric wire (electric wire corresponding to the insulated electric wire 2) was formed of two layers. In the insulating layer formed of two layers, an inner layer (a layer adjacent to the outer periphery of the conductor) was formed of EVA (a relatively flexible resin), and an outer layer was formed of polyethylene (a relatively hard resin). The total thickness of the insulating layer was the same as the thickness of the insulating layer formed of one layer according to Example 1 (the same shall be applied to Example 2).

### Example 6

A six-core insulated electric cable was prepared, the cable having the same configuration as that of Example 3 except that the insulating layer of the insulated electric wire (electric wire corresponding to the insulated electric wire 2) was formed of two layers. In the insulating layer formed of two layers, an inner layer (a layer adjacent to the outer periphery of the conductor) was formed of EVA (a relatively flexible resin), and an outer layer was formed of polyethylene (a relatively hard resin). The total thickness of the insulating layer was the same as the thickness of the insulating layer formed of one layer according to Example 1 (the same shall be applied to Example 3).

### Comparative Example 1

A two-core insulated electric cable was prepared, the cable having the same configuration as that of Example 1 except that the conductor of the insulated electric wire was formed of an annealed copper wire instead of the hard-drawn copper wire.

### Comparative Example 2

A four-core insulated electric cable was prepared, the cable having the same configuration as that of Example 2 except that the conductor of the insulated electric wire was formed of an annealed copper wire instead of the hard-drawn copper wire.

### Comparative Example 3

A six-core insulated electric cable was prepared, the cable having the same configuration as that of Example 3 except that the conductor of the insulated electric wire was formed of an annealed copper wire instead of the hard-drawn copper wire.

### Comparative Example 4

60 wires having an outer diameter of 0.08 mm which were formed of a copper alloy wire were stranded to form a child stranded conductor (stranded wire) 5, and 7 child stranded conductors 5 were stranded to form a conductor having an outer diameter 2.1 mm as a stranded wire. The outer periphery of the conductor was covered with an insulating layer formed of polyethylene to form an insulated electric wire having an outer diameter of 2.9 mm. Two insulated electric wires were twisted to form a core wire (twisted pair), and the outer periphery of the core wire was covered with a sheath formed of polyurethane. As a result, an insulated electric cable having an outer diameter of 8.2 mm was prepared. The thickness (thickness of the thinnest portion) of the sheath was 1.15 mm. The outer diameter of the insulated electric cable was larger than that of Example 1 by 6%.

### Comparative Example 5

Two insulated electric wires having the same configuration as that of Comparative Example 4 and a sub-unit having the same configuration as that of Example 2 were stranded and covered with a sheath having the same configuration as that of Example 2. As a result, a four-core insulated electric cable was prepared. The thickness (thickness of the thinnest portion) of the sheath was 1.15 mm. The outer diameter of the insulated electric cable was 9.2 mm which was larger than that of Example 2 by 7%.

### Comparative Example 6

Two insulated electric wires having the same configuration as that of Comparative Example 4 and two sub-units having the same configuration as that of Example 3 were twisted and covered with a sheath having the same configuration as that of Example 3. As a result, a six-core insulated electric cable was prepared. The thickness (thickness of the thinnest portion) of the sheath was 1.15 mm. The outer diameter of the insulated electric cable was 10.0 mm which was larger than that of Example 3 by 7%.

In Comparative Examples 4 to 6, the diameter of the child stranded conductor formed of a copper alloy wire is larger than that of the child stranded conductor formed of the hard-drawn copper wire in Example 1. Therefore, the stranding pitch of the child stranded conductor was 45 mm, and the twisting pitch of the core wire was 85 mm.

In the insulated electric cables according to Comparative Examples 4 to 6, the allowable current of the insulated electric wire was 9.8 mΩ/m.

### Bending Test

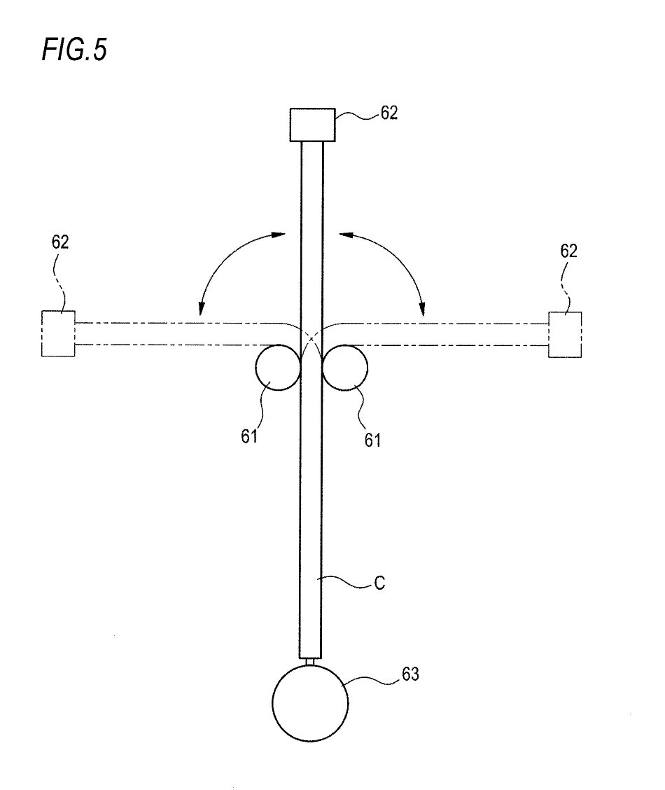

The bending resistance of the insulated electric cable was evaluated based on the result of a bending test defined according to ISO 14572:2011 (E) 5.9. In the bending test, as illustrated in FIG. 5, a cable C is caused to pass through a pair of mandrels 61 (the diameter of the mandrel 61 was 40 mm), the cable C was lowered, an upper end of the cable C was held by a chuck 62, and a 2 kg weight 63 was attached to a lower end of the cable C. In an environment of −30° C., by swinging the chuck 62 like a pendulum along a circumference centering on a gap between the mandrels 61, the cable C was repeatedly bent to the respective mandrels 61 side in a range of −90° to +90°. The number of times of bending was counted until the conductor of the insulated electric wire (the first insulated electric wire) constituting the cable C broke (a decrease rate of the resistance value of the conductor exceeded 5%). In a case where the cable C started moving from the vertical state and returned to the vertical state again after being bent in a range of +90° to −90°, the number of times of bending was increased by one.

### Test Result

In Example 1, the conductor 3 of the two-core insulated electric cable 10 did not break even after performing the bending test 70,000 times. In addition, in each of the insulated electric cables according to Examples 2 and 3, the conductor 3 did not break even after performing the bending test 70,000 times. In each of the insulated electric cables according to Examples 4 to 6, the conductor 3 did not break even after performing the bending test 200,000 times. In Examples 4 to 6, the insulating layer was formed of two layers, the inner layer was formed of a relatively flexible resin, and the outer layer was formed of a relatively hard resin. As a result, the bendability was further improved.

On the other hand, in Comparative Example 1, the conductor of the two-core insulated electric cable broke when the number of times of bending was less than 10,000. In addition, in each of the insulated electric cables according to Comparative Examples 2 and 3, the conductor broke when the number of times of bending was less than 10,000. As a result, it was found that the bending resistance of Examples 1 to 6 was higher than that of Comparative Examples 1 to 3.

In Comparative Example 4, the conductor of the two-core insulated electric cable did not break even after performing the bending test 100,000 times or more. In addition, in each of the insulated electric cables according to Comparative Examples 5 and 6, the conductor did not break even after performing the bending test 100,000 times or more. As a result, it was found that the bending resistance of Examples 1 to 6 and Comparative Examples 4 to 6 was high. As described above, the outer diameter of the insulated electric cable 10 according to each of Examples 1 to 6 was reduced by 6 to 7% compared to that of each of Comparative Examples 4 to 6.

It was found from the above-described results that, in Examples 1 to 6, reduction in diameter and high bending resistance of the cable were able to be achieved.

1. A multicoaxial cable comprising:
a core wire which includes a first unit formed by twisting two first insulated electric wires, each of the first insulated electric wires including a conductor and an insulating layer, the conductor being formed by stranding a plurality of child stranded conductors, each of the child stranded conductors consisting of a plurality of hard-drawn copper wires having an outer diameter of 0.05 mm to 0.16 mm inclusive, and the insulating layer being formed to cover the conductor; and
a sheath which covers the core wire, wherein
a cross-sectional area of the conductor is 1.2 mm² to 3.5 mm²,
an outer diameter of the insulating layer is 2.0 mm to 3.6 mm, and
the sheath includes a first cover layer and a second cover layer, the first cover layer covers a periphery of the core wire and is formed by polyurethane, and the second cover layer covers a periphery of the first cover layer.

2. A multicoaxial cable comprising:
a core wire which is formed using a plurality of first insulated electric wires and a plurality of second insulated electric wires,
each of the first insulated electric wires including a first conductor and a first insulating layer, the first conductor of the first insulated electric wire being formed by stranding a plurality of child stranded conductors, each of the child stranded conductors of the first insulated electric wire being formed by stranding a plurality of conductor wires, and the first insulating layer of the first insulated electric wire being formed to cover the first conductor,
each of the second insulated electric wires including a second conductor and a second insulating layer, the second conductor of the second insulated electric wire being formed of a plurality of conductor wires, and the second insulating layer of the second insulated electric wire being formed to cover the second conductor; and
a sheath which covers the core wire, wherein
a cross-sectional area of the first conductor of the first insulated electric wire is 1.2 mm² to 3.5 mm²,
an outer diameter of the first insulating layer of the first insulated electric wire is 2.0 mm to 3.6 mm,
a cross-sectional area of the second conductor of the second insulated electric wire is 0.13 mm² to 0.75 mm²,
an outer diameter of the second insulating layer of the second insulated electric wire is 1.0 mm to 2.2 mm, and
the core wire is formed by twisting two of the second insulated electric wires, and twisting two of the first insulated electric wires with the twisted second insulated electric wires.

3. The multicoaxial cable according to claim 2, wherein
the core wire further includes a third unit which is formed by twisting two third insulated electric wires,
each of the third insulated electric wires includes a conductor and an insulating layer,
the conductor has a cross-sectional area of 0.13 mm² to 0.75 mm²,
the insulating layer is formed to cover the conductor and has an outer diameter of 1.0 mm to 2.2 mm, and
the core wire is formed by stranding the first insulated electric wires, the second unit, and the third unit with each other.

4. (canceled)

5. The multicoaxial cable according to claim 1, wherein
the first cover layer is formed of a material which is more flexible than that of the second cover layer.

6. The multicoaxial cable according to claim 1, wherein
the first cover layer is formed of a foamed material.

7. The multicoaxial cable according to claim 1, further comprising:
a tape member which is disposed between the core wire and the sheath in a state of being wrapped around a periphery of the core wire.

8. The multicoaxial cable according to claim 1, wherein
powder is applied to the periphery of the core wire, and the periphery of the core wire to which the powder is applied is covered with the sheath.

9. The multicoaxial cable according to claim 1, wherein
a stranding pitch at which the child stranded conductors are stranded is less than a twisting pitch at which the two first insulated electric wires are twisted, and
the twisting pitch at which the two first insulated electric wires are twisted is from one to four times the stranding pitch at which the child stranded conductors are stranded.
